(19) United States
(12) Patent Application Publication
(10) Pub. No.: US 2002/0031659 A1
(43) Pub. Date: Mar. 14, 2002

(54) Composite material

(75) Inventors: Peter Gansen, Seeburg (DE); Zeev Biro, Haan (DE); Adolf Stender, Duderstadt (DE)

Correspondence Address: HUSCH & EPPENBERGER, LLC, Suite 1400, 401 Main Street, Peoria, IL, 61602, US

(73) Assignee: Otto Bock Orthopadische Industrie Gmbh & Co.

(21) Appl. No.: 09/861,330

(22) Filed: May 18, 2001

(30) Foreign Application Priority Data
May 18, 2000 (DE) 100 24 097.6-43

(51) Int. Cl. B32B 18/00

(52) U.S. Cl. 428/325; 428/326; 428/327

(57) ABSTRACT

The composite material made from a polyurethane gel and coarse-grain solid particles distributed therein may be made to be visually appealing and at the same time facilitates utilization of the properties of a polyurethane gel in a novel composite material. The particles consist of cork, foam, textile materials etc.

### BACKGROUND OF THE INVENTION

The present invention relates generally to composite materials and, more particularly, to a composite material having a polyurethane gel.

Polyurethane gels are generally glass-clear materials having relatively high specific weight and which may be used for many applications. The gels are very elastic, impact-absorbing and shock-absorbing and can be deformed with good recovery values.

The gels claimed in patent specification EP 0 057 838 for avoiding decubitus are characterized by a low characteristic, that is by so-called undercuring. They are produced by reacting a polyisocyanate with long-chain polyols that are free of short-chain portions. These dimensionally stable gels comprised of polyurethane raw materials may be used as mattresses, mattress fillings, car seats and upholstered furniture. These polyurethane gels produced by undercuring are characterized by dimensional stability, excellent mechanical properties and tackiness. The tackiness is often perceived as an undesired characteristic. A tack-free surface may be achieved by surrounding the gel with different types of coatings.

Patent specification EP 0 511 570 discloses gels made from polyols and polyisocyanates having a low characteristic, which are produced from mixtures of long-chain and short-chain polyethers. These gels are more favorable in terms of processing technology and may be used as padding in shoes, on the seat surfaces of bicycle saddles, as supports for avoiding or preventing injuries, in face masks and in padding below horse saddles, as well as various other applications.

The high weight and the high thermal capacity of seat cushions made from pure gel is generally regarded as a disadvantage. The high thermal capacity may lead to a cold seat feeling, since body heat is perceptibly removed to heat a cushion made from gel.

Lower weight fillers have been used in order to make these gels lighter. Fillers for plastics are generally known for use in various applications. For example, fillers may be used in plastic processing for improvement in mechanical properties, lowering of material costs and recycling of raw materials which otherwise can no longer be used. Different types of fillers are also relatively well-known in the field of polyurethane chemistry. Specific fillers exist in various manifestations of materials made from polyurethanes. For example, melamine is used to improve flame resistance in soft foam. In the field of solid polyurethane elastomers—the so-called RIM products—glass is admixed to increase the strength of the reacting components. However, in the polyurethane gels, which are conventionally as clear as glass in pure form, the use of fillers leads to milky-cloudy appearance, which causes the material to appear visually unattractive.

The problem underlying the invention therefore consists in providing a material based on polyurethane gel, which minimizes the disadvantages described above, while preserving a visually attractive exterior. If possible, a reduction in the specific weight and a reduction in the cold feeling on body contact should also be achieved.

The present invention is directed to overcoming one or more of the problems set forth above.

### BRIEF SUMMARY OF THE INVENTION

In one aspect of this invention, a composite material is disclosed. This composite material includes a polyurethane gel including coarse-grain solid particles distributed therein.

In another aspect of this invention, a molding made from a composite material is disclosed. This molding includes a polyurethane gel including coarse-grain solid particles distributed therein, wherein the diameter of the coarse-grain solid particles is in a range between 0.1 mm to 1 cm (0.003937 to 0.3937 in).

Still another aspect of this invention discloses a composite material. This composite material includes a polyurethane gel including coarse-grain solid particles distributed therein, wherein the diameter of the coarse-grain solid particles is in a range between 0.1 mm to 1 cm (0.003937 to 0.3937 in) utilized in a product selected from the group consisting of shoes uppers, shoe insoles, mattresses, seat supports, seat cushions or carpet back coatings.

The above aspects are merely illustrative examples of a few of the innumerable aspects associated with the present invention and should not be deemed an all-inclusive listing in any manner whatsoever.

### DETAILED DESCRIPTION OF THE INVENTION

In accordance with the present invention there is provided a composite material made from a polyurethane gel and coarse-grain solid particles distributed therein, wherein the diameter of the solid particles is advantageously between 0.1 mm to 1 cm (0.003937 to 0.3937 in). The material of the present invention advantageously has an interesting, appealing appearance and at the same time good material properties which can be adjusted by shape, size and type of the particles. The visual appearance is determined by the coarse grain property of the incorporated particles, and specifically in a wide range, which can be determined by selecting the particles and the particle size. Since the particles can be recognized discretely, a visually novel gel composite material is produced.

The incorporation of lighter, i.e., density less than 1.5 kg per liter (12.517 lb per gal), and relatively coarse-grain solids is preferred.

Solid materials, which are produced from natural materials, such as cork for example, are preferred. The solid may reduce the thermal conductivity of the gel. Likewise, in most cases, the composite material according to the present invention has less tackiness. However, the visual attractiveness of the resulting composite material of the invention is particularly noteworthy.

The solids are characterized in that they have a particle size of 0.1 mm to about 1 cm (0.003937 to 0.3937 in). Hence, they are discrete particles, which can be differentiated by the eye. The composite material is visibly grainy. The geometry of the particles is generally irregular. The combination of the gel, which is as clear as glass in the basic state, with the irregular solid gives an attractive appearance to the composite material parts of the invention.

The diameter of the solid particles is preferably between 0.1 and 15 mm (0.003937 to 0.5906 in).

The solid particles are added in such a quantity that they account for 5 to 90 percent by volume, but preferably 20 to 70 percent by volume, of the final product.

The solids used according to the invention are furthermore preferably of organic nature. Solids according to the invention may include, for example, cork pieces, cork flour, wood pieces, wood chips, sawdust, foam flakes, residues of textiles, textile fibers and foam residues of different flake size. These foams may be any type of foamed plastics and, in particular, polyurethane materials. They may also be solids of an open-celled and/or closed-celled nature.

The gel compositions of the polyurethane gel are preferably produced using raw materials of isocyanate functionality and functionality of the polyol component of at least 7.5. The polyol component of the gel may preferably consist of a mixture of

one or more polyols having hydroxyl numbers below 112, and

one or more polyols having hydroxyl numbers in the range 112 to 600,

wherein the weight ratio of component a) to component b) lies between 90:10 and 10:90, the isocyanate characteristic of the reaction mixture lies in the range from 15 to 60 and the product of isocyanate functionality and functionality of the polyol component is at least 6.

The polyol component may consist of one or more polyols having a molecular weight between 1,000 and 1,200 and an OH number between 20 and 112, wherein the product of the functionalities of the polyurethane-forming components is at least 5 and the isocyanate characteristic lies between 15 and 60.

As isocyanate for polyurethane production of the formula Q(NCO)ₙ, wherein n represents 2 to 4 and Q denotes an aliphatic hydrocarbon radical having 6 to 18 C atoms, a cycloaliphatic hydrocarbon radical having 4 to 15 C atoms, an aromatic hydrocarbon radical having 6 to 15 C atoms or an araliphatic hydrocarbon radical having 8 to 15 C atoms, may be used.

The isocyanates may be used in pure form or in the form of conventional isocyanate modifications, but preferably urethanized, allophanatized or biuretized.

The invention also includes moldings made from the described composite material of the invention.

Preferred applications for the composite material of the present invention or moldings produced therefrom are shoe insoles, foot rests, shoe soles, whole shoes, seat supports, mattresses, armchairs, seat cushions, bicycle saddles or even carpet back coatings, and various damping elements. Many other applications are conceivable.

Properties, such as water uptake can be controlled specifically by selecting a suitable cover material or a suitable cover layer in combination with the appropriate filler. During water uptake, the positive water uptake properties of the pure gel are advantageous. For use as insole material, the wearer comfort or the mechanical property profile, may be adjusted specifically by varying the solids content and the hardness of the gel.

Combinations of the material according to the invention with foams, plastics, metals or other materials to form sandwich constructions are possible, given the adhesiveness of the material.

### EXAMPLES

The patterns of preferred embodiments of the invention were produced by mixing the polyol component with the solid and then adding the isocyanate. A conventional laboratory stirrer was used. The production of moldings by introducing the reacting polyol-solid-isocyanate mixture into an open or closed mold corresponds to conventional process technology. The continuous production of blocks made from the raw materials of the invention is likewise possible.

### Example 1

200 ml (6.763 fluid oz) of a trifunctional polyether polyol of OH number 36, which is treated with 0.05 wt. % of a catalyst (Coscat 83 from Messrs. Cosan Chemicals Co.), is mixed intensively with 200 ml (6.763 fluid oz) of a cork powder of average particle size of about 1 mm (0.03937 in). The resulting composition is then mixed with 27.6 g (0.9736 oz) of a modified aliphatic isocyanate (Desmodur KA 8114 from Bayer AG) by means of a laboratory stirrer. The reacting mixture is cast into a plate mold having the dimensions 20×20×1 cm (7.874×7.874×0.3937 in). After three minutes, the molding is removed from the mold. It has a similar appearance to a cork sole. The mechanical properties are as follows:

| | | |
|---|---|---|
| Density: | 0.8 | g/l (.01336 oz/pt) |
| Shore L: | 46 | |
| Tensile strength: | 320 | kPa |
| Extension at break: | 130% | |

### Example 2

300 ml (10.14 fluid oz) of a trifunctional polyether polyol of OH number 36, which is treated with 0.05 wt. % of a catalyst (Coscat 83 from Messrs. Cosan Chemical Co.), is mixed intensively with 150 ml (5.072 fluid oz) of a cork powder of particle size averaging about 1 mm (0.03937 in). The reacting mixture is cast into a plate mold having the dimensions 20×20×1 cm (7.874×7.874×0.3937 in). After three minutes, the molding is removed from the mold. It has a similar appearance to a cork sole. The mechanical properties are as follows:

| | | |
|---|---|---|
| Density: | 0.8 | g/l (.01336 oz/pt) |
| Shore A: | 39 | |
| Tensile strength: | 280 | kPa |
| Extension at break: | 310% | |

### Example 3

150 ml (5.072 fluid oz) of a trifunctional polyether polyol of OH number 36, which is treated with 0.05 wt. % of a catalyst (Coscat 38 from Messrs. Cosan Chemical Co.), is mixed intensively with 300 ml (10.14 fluid oz) of a cork powder of average particle size of about 1 mm (0.03937 in). The resulting composition is then mixed with 20.8 g (0.7337 oz) of a modified aliphatic isocyanate (Desmodur KA 8114 from Bayer AG) by means of a laboratory stirrer. The reacting mixture is cast into a plate mold having the dimensions 20×20×1 cm (7.874×7.874×0.3937 in). After three minutes, the molding is removed from the mold. It has a similar appearance to a cork sole. The mechanical properties are as follows:

| | | |
|---|---|---|
| Density: | 0.7 | g/l (.01168 oz/pt) |
| Shore A: | 56 | |
| Tensile strength: | 440 | kPa |
| Extension at break: | 118% | |

### Comparative Example

400 ml (13.53 fluid oz) of a trifunctional polyether polyol of OH number 36, which is treated with 0.05 wt. % of a catalyst (Coscat 83 from Messrs. Cosan Chemical Co.), is mixed with 13 g (0.4586 oz) of a modified aliphatic isocyanate (Desmodur KA 8114 from Bayer AG) by means of a laboratory stirrer. The reacting mixture is cast into a plate mold having the dimensions 20×20×1 cm (7.874×7.874×0.3937 in). After three minutes, the molding is removed from the mold. It has a slightly milky appearance due to the air bubbles resulting during stirring. The mechanical properties are as follows:

| | | |
|---|---|---|
| Density: | 1.1 | g/l (.01836 oz/pt) |
| Shore A: | 34 | |
| Tensile strength: | 263 | kPa |
| Extension at break: | 437% | |

The molding made from pure gel feels significantly colder.

The Shore hardness can be adjusted specifically by varying the cork portion. Furthermore, no negative effect on tensile strength can be established. The positive influence of the incorporated cork on the appearance of the molding and on the density should be emphasized.

Other objects, features and advantages will be apparent to those skilled in the art. While preferred embodiments of the present invention have been illustrated and described, this has been by way of illustration and the invention should not be limited except as required by the scope of the appended claims.

We claim:

1. A composite material comprising:
a polyurethane gel including coarse-grain solid particles distributed therein.

2. The composite material according to claim 1, wherein the diameter of the coarse-grain solid particles is in a range between 0.1 mm to 1 cm.

3. The composite material according to claim 1, wherein the diameter of the coarse-grain solid particles is in a range between 0.1 mm to 15 mm.

4. The composite material according to claim 1, wherein the coarse-grain solid particles are in a range of between 5 to 90 percent of the composite material's total volume.

5. The composite material according to claim 1, wherein the coarse-grain solid particles are in a range of between 20 to 70 percent of the composite material's total volume.

6. The composite material according to claim 1, wherein the coarse-grain solid particles includes organic materials.

7. The composite material according to claim 1, wherein the coarse-grain solid particles are selected from the group consisting of cork pieces, cork flour, wood pieces, wood chips, foam flakes, textile fibers or textile pieces.

8. The composite material according to claim 1, wherein the polyurethane gel includes compositions produced from raw materials having isocynate functionality and a polyol component with a functionality of at least 7.5.

9. The composite material according to claim 8, wherein the polyol component for producing the polyurethane gel includes of a mixture of
one or more polyols having hydroxyl numbers below 112; and
one or more polyols having hydroxyl numbers in the range 112 to 600, wherein the weight ratio of the one or more polyols having hydroxyl numbers below 112 to the one or more polyols having hydroxyl numbers in the range 112 to 600 is in a range of between 90:10 and 10:90.

10. The composite material according to claim 9, wherein the isocyanate characteristic of the reaction mixture lies in the range from 15 to 60.

11. The composite material according to claim 10, wherein the product of isocyanate functionality and functionality of the polyol component is at least 6.

12. The composite material according to claim 8, wherein the polyol component used in producing the polyurethane gel includes one or more polyols having a molecular weight between 1,000 and 12,000 and an OH number in a range between 20 and 112, wherein the product of the functionalities of the polyurethane-forming components is at least 5.2 and the isocyanate characteristic is in a range between 15 and 60.

13. The composite material according to claim 8, wherein the isocyanates, used in producing the polyurethane gel, has a formula Q(NCO)ₙ, wherein n represents 2 to 4 and Q is selected from the group consisting of an aliphatic hydrocarbon radical having 6 to 18 C atoms, a cycloaliphatic hydrocarbon radical having 4 to 15 C atoms, an aromatic hydrocarbon radical having 6 to 15 C atoms or an araliphatic hydrocarbon radical having 8 to 15 C atoms.

14. The composite material according to claim 8, wherein the isocyanates are in a pure form.

15. The composite material according to claim 8, wherein the isocyanates are modified conventional isocyanates.

16. The composite material according to claim 8, wherein the isocyanates are urethanized.

17. The composite material according to claim 8, wherein the isocyanates are allophanatized.

18. The composite material according to claim 8, wherein the isocyanates are biuretized.

19. A molding made from a composite material comprising:
a polyurethane gel including coarse-grain solid particles distributed therein,
wherein the diameter of the coarse-grain solid particles is in a range between 0.1 mm to 1 cm.

20. A composite material comprising:
a polyurethane gel including coarse-grain solid particles distributed therein, wherein the diameter of the coarse-grain solid particles is in a range between 0.1 mm to 1 cm utilized in a product selected from the group consisting of shoes uppers, shoe insoles, mattresses, seat supports, seat cushions or carpet back coatings.
